(19) United States
(12) Patent Application Publication
(10) Pub. No.: US 2019/0356685 A1
(43) Pub. Date: Nov. 21, 2019

(54) DETECTION AND LOCALIZATION OF ATTACK ON A VEHICLE COMMUNICATION NETWORK

(71) Applicant: GM Global Technology Operations LLC, Detroit, MI (US)

(72) Inventors: Mohammad Naserian, Windsor (CA); Donald K. Grimm, Utica, MI (US); Allan K. Lewis, Windsor (CA)

(21) Appl. No.: 15/983,842

(22) Filed: May 18, 2018

(51) Int. Cl. H04L 29/06; H04W 4/40; G01S 5/02; G01S 11/04; G08B 25/10

(52) U.S. Cl. CPC H04L 63/1425; H04L 63/1458; G08B 25/10; G01S 5/0289; G01S 11/04; H04W 4/40

(57) ABSTRACT

Embodiments include methods, systems and computer readable storage medium for determining an attack on a vehicle network and an estimated source location of an attacker. The method includes receiving, by a processor, a plurality of messages. The method further includes analyzing, by the processor, each of the plurality of messages to determine that each of the plurality of messages is suspicious. The method further includes determining, by the processor, that an attack is occurring in response to a determination that multiple messages of the plurality of messages are suspicious. The method further includes localizing, by the processor, a source location for the attack using an angle of arrival associated with each of the plurality of suspicious messages to determine a source intersection. The method further includes notifying, by the processor, one or more vehicles of the attack.

### INTRODUCTION

The subject disclosure relates to vehicle safety, and more specifically to determining a location of a malicious attack on a vehicle network.

Autonomous vehicles are automobiles that have the ability to operate and navigate without human input. Autonomous vehicles use sensors, such as radar, LIDAR, global positioning systems, and computer vision, to detect the vehicle's surroundings. Advanced computer control systems interpret the sensory input information to identify appropriate navigation paths, as well as obstacles and relevant signage. Some autonomous vehicles update map information in real time to remain aware of the autonomous vehicle's location even if conditions change or the vehicle enters an uncharted environment. Autonomous vehicles as well as non-autonomous vehicles increasingly communicate with remote computer systems and with one another using V2X communications—Vehicle-to-Everything, Vehicle-to-Vehicle (V2V), Vehicle-to-Infrastructure (V2I)).

V2V involves a dynamic wireless exchange of data between nearby vehicles. V2V uses on-board dedicated short-range communication (DSRC) radio devices or similar devices to transmit messages about a vehicle's speed, heading, brake status, and other information to other vehicles and receive the same messages from other vehicles. These messages are known as Wireless Safety Messages (WSMs). WSMs can employ a variety of formats. For example, in Europe, WSM formats used to send and receive messages are a Cooperative Awareness Message (CAM) or a Decentralized Environmental Notification Message (DENM). In North America, the WSM format used to send and receive messages is a Basic Safety Message (BSM). In China, the WSM format used to send and receive messages is a Cellular Vehicle-to-Everything (C-V2X). WSMs can he derived using non-vehicle-based technologies such as global positioning system (GPS) to detect a location and speed of a vehicle, or using vehicle-based sensor data where the location and speed data is derived from the vehicle's on-board computer. Accordingly, exchanging messages with other vehicles using V2V enables a vehicle to automatically sense the position of surrounding vehicles with 360-degree awareness as well as potential hazards present, calculate risk based on the position, speed, or trajectory of surrounding vehicles, issue driver advisories or warnings, and take pre-eruptive actions to avoid and mitigate crashes.

A denial-of-service (DoS) attack is a cyber-attack in which perpetrators seek to cause a machine or network resource to become unavailable for use. DoS attacks are typically accomplished by flooding a targeted machine or resource with superfluous requests in an attempt to overload the target machine or a system associated with the target machine.

Accordingly, it is desirable to provide a system that can detect an attack on a vehicle network and determine a source location for the attack. The attack can be mitigated by providing the source location to authorities.

### SUMMARY

In one exemplary embodiment, a method for determining an attack on a vehicle network and an estimated source location of an attacker is disclosed. The method includes receiving, by a processor, a plurality of messages. The method further includes analyzing, by the processor, each of the plurality of messages to determine that each of the plurality of messages is suspicious. The method further includes determining, by the processor, that an attack is occurring in response to a determination that multiple messages of the plurality of messages are suspicious. The method further includes localizing, by the processor, a source location for the attack using an angle of arrival associated with each of the plurality of suspicious messages to determine a source intersection. The method further includes notifying, by the processor, one or more vehicles of the attack.

In addition to one or more of the features described herein, one or more aspects of the described method can additionally be related to reporting the attack to one or more authorities. Another aspect of the method can additionally be related to providing the source location to the authorities. Another aspect of the method is that determining whether each of the plurality of messages is suspicious comprises determining, by the processor, a message type associated with the message, calculating, by the processor, the AoA for the message, wherein the AoA is an angle of receipt for the message and comparing, by the processor, the AoA to a message angle, wherein the message angle is an expected angle of receipt or angle range for the message based on the message type. Another aspect of the method is that determining that an attack is occurring further comprises determining that the vehicle network is operating in a degraded state. Another aspect of the method is that localizing the source location for the attack further uses a received signal strength associated with each of the plurality of suspicious messages. Another aspect of the method is that the vehicle network is a Vehicle-to-Everything communications network. Another aspect of the method is that the received message is a wireless safety message.

In another exemplary embodiment, a system for determining an attack on a vehicle network and an estimated source location of an attacker is disclosed herein. The system includes one or more vehicles in which each vehicle includes a memory and processor and in which the processor is operable to receive a plurality of messages. The processor is further operable to analyze each of the plurality of messages to determine whether each of the plurality of messages is suspicious. The processor is further operable to determine that an attack is occurring in response to a determination that multiple messages of the plurality of messages are suspicious. The processor is further operable to localize a source location for the attack using an angle of arrival associated with each of the plurality of suspicious messages to determine a source intersection. The processor is further operable notify the one or more vehicles of the attack.

In yet another exemplary embodiment a computer readable storage medium for determining an attack on a vehicle network and an estimated source location of an attacker is disclosed herein. The computer readable storage medium includes receiving a plurality of messages. The computer readable storage medium further includes analyzing each of the plurality of messages to determine whether each of the plurality of messages is suspicious. The computer readable storage medium further includes determining that an attack is occurring in response to a determination that multiple messages of the plurality of messages are suspicious. The computer readable storage medium further includes localizing a source location for the attack using an angle of arrival associated with each of the plurality of suspicious messages to determine a source intersection. The computer readable storage medium further includes one or more vehicles of the attack.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a computing environment according to one or more embodiments;

FIG. 2 is a block diagram illustrating one example of a processing system for practice of the teachings herein;

FIG. 3 depicts an attack 300 on a vehicle network according to one or more embodiments;

FIG. 4 depicts an interaction between one or more mobile vehicles and a security credential management system according to one or more embodiments;

FIG. 5 depicts a flow diagram of a method for determining an attack on a vehicle network and an estimated source location of an attacker according to one or more embodiments; and

FIG. 6 depicts a flow diagram of a method for determining an attack on a vehicle network and an estimated source location of an attacker according to one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

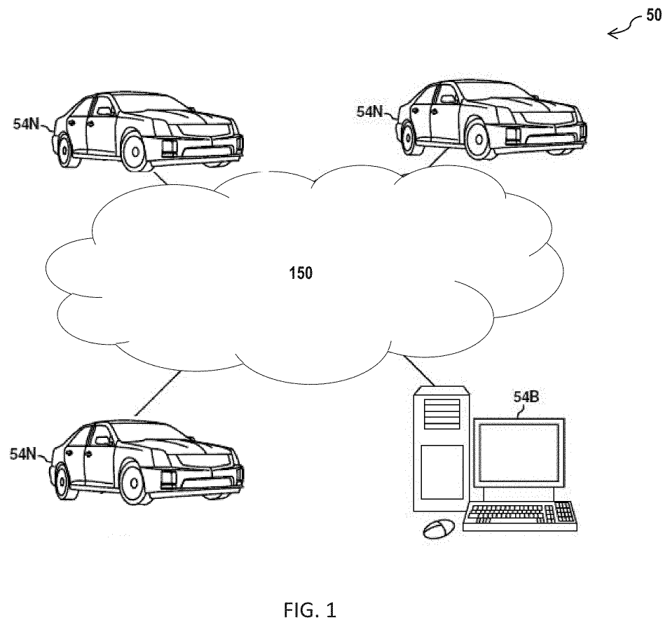

In accordance with an exemplary embodiment, FIG. 1 illustrates a computing environment 50 associated with a system for malicious wireless safety message detection using an angle of arrival. As shown, computing environment 50 comprises one or more computing devices, for example, a server 54B, and/or a plurality of automobile onboard computer systems 54N, each associated with an autonomous or non-autonomous vehicle, which are connected via network 150. The one or more computing devices can communicate with one another using network 150.

Network 150 can be, for example, a cellular network, a local area network (LAN), a wide area network (WAN), such as the Internet, a dedicated short range communications network (for example, V2X communication (i.e., vehicle-to-everything), V2V communication (vehicle-to-vehicle), V2I communication (vehicle-to-infrastructure), and V2P communication (vehicle-to-pedestrian)), or any combination thereof, and may include wired, wireless, fiber optic, or any other connection. Network 150 can be any combination of connections and protocols that will support communication between server 54B and/or the plurality of vehicle on-board computer systems 54N, respectively.

Each of the plurality of vehicle on-board computer systems 54N can include a GPS transmitter/receiver (not shown) which is operable for receiving location signals from the plurality of GPS satellites (not shown) that provide signals representative of a location for each of the mobile resources, respectively. In addition to the GPS transmitter/receiver, each vehicle associated with one of the plurality of vehicle on-board computer systems 54N may include a navigation processing system that can be arranged to communicate with a server 54B through the network 150. Accordingly, each vehicle associated with one of the plurality of vehicle on-board computer systems 54N are able to determine location information and transmit that location information to the server 54B or another vehicle on-board computer system 54N.

Additional signals sent and received may include data, communication, and/or other propagated signals. Further, it should be noted that the functions of transmitter and receiver can be combined into a signal transceiver.

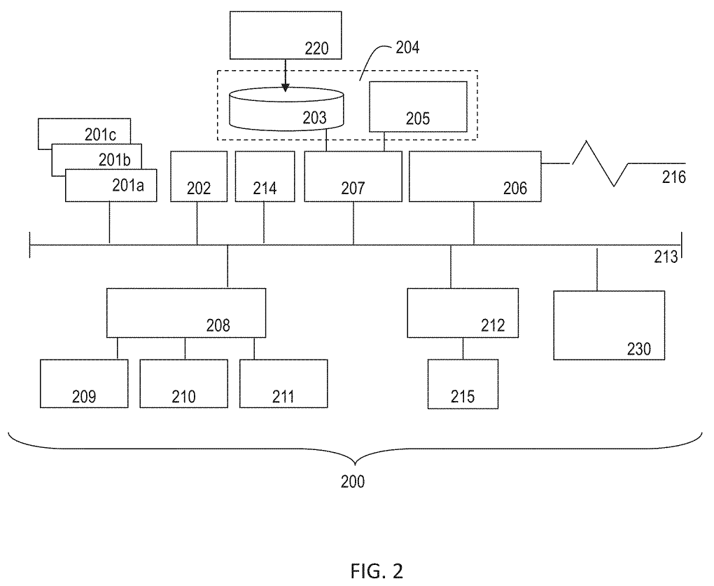

In accordance with an exemplary embodiment, FIG. 2 illustrates a processing system 200 for implementing the teachings herein. The processing system 200 can form at least a portion of the one or more computing devices, such as the server 54B, and/or each of the plurality of vehicle on-board computer systems 54N. The processing system 200 may include one or more central processing units (processors) 201a, 201b, 201c, etc. (collectively or generically referred to as processor(s) 201). Processors 201 are coupled to system memory 214 and various other components via a system bus 213. Read only memory (ROM) 202 is coupled to the system bus 213 and may include a basic input/output system (BIOS), which controls certain basic functions of the processing system 200.

FIG. 2 further depicts an input/output (I/O) adapter 207 and a network adapter 206 coupled to the system bus 213. I/O adapter 207 may be a small computer system interface (SCSI) adapter that communicates with a hard disk 203 and/or other storage drive 205 or any other similar component. I/O adapter 207, hard disk 203, and other storage device 205 are collectively referred to herein as mass storage 204. Operating system 220 for execution on the processing system 200 may be stored in mass storage 204. A network adapter 206 interconnects bus 213 with an outside network 216 enabling data processing system 200 to communicate with other such systems. A screen (e.g., a display monitor) 215 can be connected to system bus 213 by display adaptor 212, which may include a graphics adapter to improve the performance of graphics intensive applications and a video controller. In one embodiment, adapters 207, 206, and 212 may be connected to one or more I/O busses that are connected to system bus 213 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 213 via user interface adapter 208 and display adapter 212. A keyboard 209, mouse 210, and speaker 211 can all be interconnected to bus 213 via user interface adapter 208, which may include, for example, a Super I/O chip integrating multiple device adapters into a single integrated circuit.

The processing system 200 may additionally include a graphics-processing unit 230. Graphics processing unit 230 is a specialized electronic circuit designed to manipulate and alter memory to accelerate the creation of images in a frame buffer intended for output to a display. In general, graphics-processing unit 230 is very efficient at manipulating computer graphics and image processing, and has a highly parallel structure that makes it more effective than general-purpose CPUs for algorithms where processing of large blocks of data is done in parallel.

Thus, as configured in FIG. 2, the processing system 200 includes processing capability in the form of processors 201, storage capability including system memory 214 and mass storage 204, input means such as keyboard 209 and mouse 210, and output capability including speaker 211 and display 215. In one embodiment, a portion of system memory 214 and mass storage 204 collectively store an operating system to coordinate the functions of the various components shown in FIG. 2.

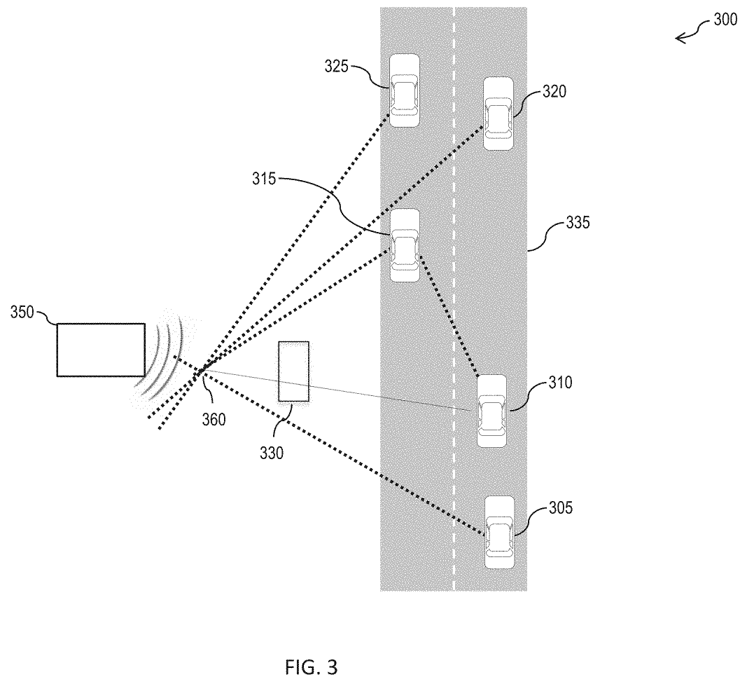

FIG. 3 depicts an attack 300 on a vehicle network according to one or more embodiments. As vehicles, for example, vehicle 305, 310, 315, 320, and 325 travel along a road network 335, the vehicles can receive a variety of information, which can be used to assist in the operation of each vehicle 305, 310, 315, 320, and 325. For example, the vehicles traveling along the road network 335 can use a vehicle-to-everything communications (V2X) network to provide status information of an associated vehicle to other vehicles connected to the V2X network. The status information can be related to, for example, a particular vehicle's speed, heading, location, braking status, environmental data such as road conditions and other information relating to a vehicle's state and predicted path.

In addition, each vehicle 305, 310, 315, 320, and 325 can receive a variety of wireless safety messages (WSMs) from other vehicles along the road network. The WSMs can be received and interpreted by an automobile onboard computer system 54N of each vehicle each vehicle 305, 310, 315, 320, and 325. The WSMs can be messages related to vehicle safety/crash avoidance.

For example, vehicles can receive an intersection collision warning (ICW), which is a warning intended to indicate an impending collision with another vehicle at an upcoming intersection. The vehicles can receive a forward collision warning (FCW), which is a warning intended to indicate an impending collision with a vehicle in front of a vehicle. The vehicles can receive an emergency electronic brake light warning (EEBL), which is a warning indicating a quick deceleration of a vehicle ahead, but not directly ahead of a vehicle. The vehicles can receive a stationary vehicle alert (SVA), which a warning intended to indicate a stopped or slow vehicle ahead. These WSMs may be provided to drivers of vehicles 305, 310, 315, 320, and 325 in order for the driver to prevent a crash, or, in an autonomous vehicle scenario, the automobile onboard computer system 54N of vehicles 305, 310, 315, 320, and 325 can use received WSMs to prevent a crash.

While the intent of WSMs is for vehicle safety/crash avoidance, unscrupulous individuals may attempt to use WSMs to flood the V2X network thereby preventing useful communications within the V2X network to occur, i.e., an attack. In a DoS attack 300, an attacker located at 350 (the attacker could be traveling in a vehicle) can attempt to render the V2X network unavailable, which could cause an accident involving one or more vehicles 305, 310, 315, 320, and 325. For example, when vehicle 305 is traveling along a road network 335, the attacker 350 can conduct a DoS attack on the V2X network preventing communications between vehicle 305 and other vehicles along the road network, for example, vehicles 310, 315, 320, and 325. Accordingly, vehicle 305 would be prevented from receiving an EEBL WSM sent by vehicle 310 potentially leading to vehicle 305 colliding with vehicle 310.

Detecting that a DoS attack or a distributed denial of service (DDoS) attack is being conducted on the V2X network is difficult. Moreover, preventing a DoS or DDoS attack that is underway is challenging due to the difficulty in finding a source location of the attack. Accordingly, a continued attack on the V2X network can paralyze the V2X network leading to dangerous driving conditions.

In light of the mentioned difficulties addressing such cyber-attacks on a V2X network, a system that detects and reports attacks by malicious individuals on a V2X communication network caused by sending excessive or malformed messages is desirable. In addition, localizing attacks in order to determining an attacker's location, which can be used by authorities/police to arrest the attacker is also desirable.

A timestamped angle of arrival (AoA) and received signal strength (RSS) readings associated with a physical layer of a wireless communications channel can be used to estimate a location origin of a stationary attacker. Mobile attackers can also be tracked by capturing GPS trace information. The physical layer can be used to send and receive WSMs between the vehicles 305, 310, 315, 320, and 325, and a security credential management system, for example server 54B. Communications of WSMs associated with each of the vehicles 305, 310, 315, 320, and 325 can be used to estimate a position for each vehicle. The physical layer can also be used to correlate an AoA for each WSM received at each antenna of vehicles 305, 310, 315, 320, and 325 based on an associated RSS.

As vehicles 305, 310, 315, 320, and 325 are traveling along a road network 335, the automobile onboard computer system 54N for each vehicle 305, 310, 315, 320, and 325 processes the received WSMs and accesses a validity of each WSM based on the presence of a valid certificate. If the certificate is invalid, or the WSM timing does not conform to an expected update frequency, the WSM (or series of WSMs) is identified as suspicious, and the AoA and RSS information is recorded and communicated to the security credential management system for processing. The security credential management system can aggregate the received WSM messages, as well as any associated AoA and RSS information. The security credential management system can use the AoA and RSS information for each of the aggregated WSMs to localize the position of the attacker using the angle information associated with AoA and a distance measurement determined using from numerous RSS information.

Upon the security credential management system determining that a DDoS attack is underway, the security credential management system can examine the timestamped AoA received from each vehicle 305, 310, 315, 320, and 325 to estimate a location of origination for the DDoS attack along with the RSS information. For example, the timestamped AoA received each vehicle 305, 310, 315, 320, and 325 can be correlated to a localized area 360, which is an estimated location for the attacker. The security credential management system can also use a range estimation based on the RSS information associated with each direct message to further localize a source location for the DDoS attack. For example, RSS readings associated with each direct message are placed into location bins (e.g., 10 meter intervals per bin) and averaged by the vehicles 305, 310, 315, 320, and 325, or the security credential management system. Accordingly, a distance of the attacker can be characterized throughout the attack and combined with the AoA to better localize the source location of the attacker. Upon determining an estimated location for the attacker, the security credential management system can report the DDoS attack and estimated location of the attacker to authorities/police.

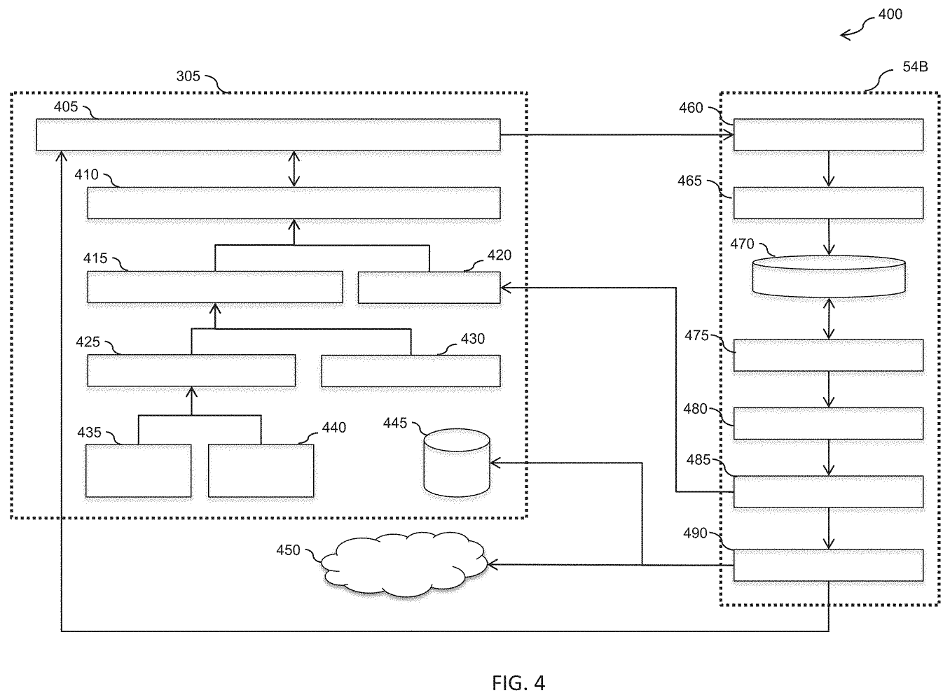

In accordance with an exemplary embodiment, FIG. 4 depicts an interaction 400 between one or more mobile vehicles and a security credential management system according to one or more embodiments. In addition to an automobile onboard computer system 54N, each of the one or more vehicles (e.g., vehicles 305, 310, 315, 320, and 325) can contain one or more applications and software components. The one or more vehicles can include, for example, security 410, misbehavior detection 415, certificate manager 420, radio services 425, location services 430, AoA estimator 435, and RSS estimator 440 software components. The one or more vehicles can also include a database 445, which can store a credentials list.

In addition to the processing system 200 described in FIG. 2, server 54B can also include, for example, receive handler 460, message analyzer 465, event monitor 475, localization engine 480, revocation engine 485 and notification engine 490 software components. The server 54B can also include an event database 470, which can store events associated with one or more received messages (WSMs).

When a vehicle, for example, vehicle 305, receives one or more wireless safety messages (WSMs), the AoA estimator 435 and RSS estimator 440 software components can be used to determine an angle of arrival (AoA) and received signal strength (RSS) for each of the WSMs. Location services software component 430 can be used to determine a location/heading for the vehicle. The misbehavior detection software component 415 can analyze the AoA and RSS for each WSM and a location/heading of the vehicle to an expected angle or angle range for receipt of the type of message received (WSM angle). For example, an EEBL WSM should be sent from a vehicle ahead (e.g. vehicle 310) of a receiving vehicle e.g., vehicle) 305. Accordingly, an expected WSM angle for the EEBL WSM can range from for example, 345 degrees to 15 degrees. If the AoA from the estimated source location for the received EEBL WSM is not within the WSM angle associated with the EEBL WSM, the misbehavior detection software component 415 can deem the EEBL WSM as a suspicious/malicious message and forward the message to a security software component 410 for comparison with an identity certificate associated with the EEBL WSM sent by the certificate manager 420. The security component 410 can use one or more applications 405 to report the receipt of a suspicious/malicious message to server 54B.

A receipt handler of server 54B can receive the suspicious/malicious message along with suspicious/malicious messages from a plurality of vehicles. Message analyzer 465 can analyze all received suspicious/malicious messages to determine if a targeted attack on vehicles within a predetermined area has occurred or whether the suspicious/malicious messages are associated with a denial of service (DOS) or distributed denial of service (DDoS) attack. Upon determining an attack type, server 54B can store the attack as an event in a database, for example, event database 470. An event monitor 475 can continually or periodically monitor stored events to determine if an attack is increasing or decreasing, or transitioning from one type of attack to another (e.g., a DoS attack transitioning to a DDoS attack).

The localization engine 480 can estimate a source location for an attack (targeted, DoS, DDoS, etc.) using AoAs and RSSs for the suspicious/malicious messages and location/heading information for each vehicle receiving the WSMs to determine a source intersection for the suspicious/malicious messages, for example, location 360 of FIG. 3. A revocation engine 485 can be used to revoke one or more certificates associated with the suspicious/malicious messages. The revocation can be sent to the certificate manager 420 of each vehicle within a predetermined area, all vehicles or a predetermined subset of all vehicles.

A notification engine 490 can send any information identifying an attacker and/or estimated location of the attacker to the vehicle for storage in the database 445, which can contain a certificate revocation list. In addition, the notification engine 490 can transmit any information identifying an attacker and/or estimated location of the attacker to authorities/police 450. The authorities/police 450 can use the received information provided by the notification engine 490 to locate and end an associated attack.

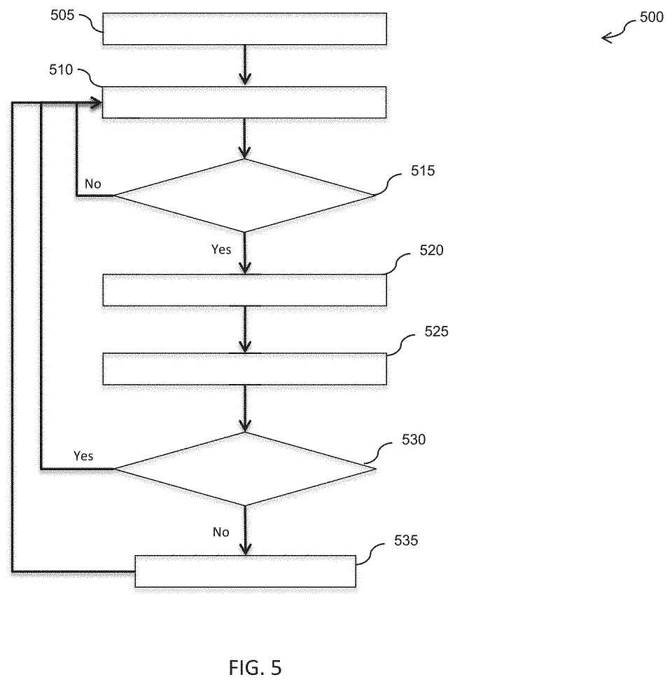

In accordance with an exemplary embodiment, FIG. 5 depicts a flow diagram of a method 500 for determining an attack on a vehicle network and an estimated source location of an attacker according to one or more embodiments. At block 505, a vehicle can receive one or more wireless safety messages (WSM). At block 510, an automobile onboard computer system of the vehicle receiving the WSM can process the one or more WSMs to determine a message type for each WSM (e.g., ICW, EEBL, FCW, etc.). At block 515, the automobile onboard computer system of a vehicle can determine whether WSMs are being received excessively and/or content associated with the received WSMs contain malformed content (i.e., messages that do not adhere to a proper syntax (e.g., messages having improperly formatted, out of range, have an inordinate amount of extra data, etc.)). If the WSMs received by the automobile onboard computer system of a vehicle are not excessive and do not contain malformed content, the method 500 returns to block 510. If the WSMs received by the automobile onboard computer system of a vehicle are excessive and/or do contain malformed content, the method 500 proceeds to block 520, where an angle of arrival (AoA) can be calculated for each of the WSMs by the automobile onboard computer system of the vehicle using a physical layer of a communications channel. At block 525, a strongest received signal strength (RSS) for each of the WSMs can be determined using the physical layer of a communications channel. The AoA and RSS can be used to determine a direction of message receipt associated with the each of the received WSMs and an estimated source location for each WSM. At block 530, the automobile onboard computer system of the vehicle can determine whether a V2X network associated with the vehicle is in a degraded state due to an attack on the V2X network (e.g., a target, DoS or DDoS attack) and the attack is known by a security credential management system. If the V2X network is operating in a degraded state due to an attack and the attack is already known by the security credential management system, the method 500 returns to block 510. If the V2X network is operating in a degraded state due to an attack and the attack is not known by the security credential management system, the method 500 proceeds to block 535 where a notification is sent to the security credential management system that an attack on the V2X network could be occurring.

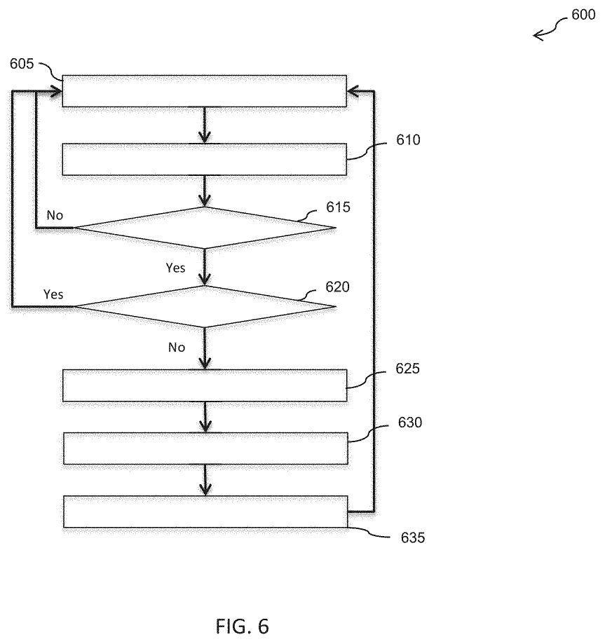

In accordance with an exemplary embodiment, FIG. 6 depicts a flow diagram of a method 600 for determining an attack on a vehicle network and an estimated source location of an attacker according to one or more embodiments. At block 605, a security credential management system, for example, server 54B, can receive one or more reports from one or more vehicles indicating receipt of one or more suspicious/malicious messages (WSMs). At block 610, security credential management system can analyze information associated with each report to obtain information about the one or more suspicious messages, for example, a message type (e.g., ICW, EEBL, FCW, etc.). The security credential management system can also analyze an expected angle of receipt for each received WSM (WSM angle). The security credential management system can also analyze a received signal strength (RSS) associated with each WSM. The security credential management system can also analyze timestamped location information for each vehicle when each WSM is received. Analysis can also include calculating an angle of arrival (AoA) for a WSM and comparing the AoA to the WSM angle for the WSM. In response to the analysis of each WSM, at block 615, the security credential management system can determine that each received WSM is suspicious/malicious, if the WSM is not suspicious/malicious, the method 600 returns to block 605. If the WSM is suspicious/malicious, the method 600 proceeds to block 620 where the security credential management system can determine whether multiple suspicious/malicious WSMs have been received, which can indicate that an attack is underway on the V2X network. If multiple suspicious/malicious WSMs have not been received, the method 600 returns to block 605. If multiple suspicious/malicious WSMs have been received, the method 600 proceeds to block 625, where the security credential management system can identify a message source/attacker location (localization) using an AoA and RSS associated with each WSM. At block 630, the security credential management system can notify each vehicle that an attack on the V2X is underway. At block 635, the security credential management system can notify authorities/police that a V2X network is underway and provide localization information associated with the attack. Accordingly, the authorities/police can find an attacker and halt the attack on the V2X network using the received localization information associated with the attack.

Accordingly, the embodiments disclosed herein describe a system that can identify an attack on a vehicle network. The system can also use an angle of arrival information and received signal strength information associated with messages determined to be suspicious to locate a stationary attacker or track movements of a mobile attacker. The system can also inform authorities regarding the location of the stationary or mobile attacker.

Technical effects and benefits of the disclosed embodiments include, but are not limited to reducing a time period for an attack on a vehicle network by identifying that an attack on the vehicle network is occurring and notifying authorities of a source location for the attack.

It is understood that although the embodiments are described as being implemented on a traditional processing system, the embodiments are capable of being implemented in conjunction with any other type of computing environment now known or later developed. For example, the present techniques can be implemented using cloud computing. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. It should be appreciated that the computing environment 50 that is associated with a system for determining an attack on a vehicle network and an estimated source location of an attacker can be implemented in a cloud computing environment.

The present disclosure may be a system, a method, and/or a computer readable storage medium. The computer readable storage medium may include computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a mechanically encoded device and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method for determining an attack on a vehicle network and an estimated source location of an attacker, the method comprising:
receiving, by a processor, a plurality of messages;
analyzing, by the processor, each of the plurality of messages to determine whether each of the plurality of messages is suspicious;
determining, by the processor, that an attack is occurring in response to a determination that multiple messages of the plurality of messages are suspicious;
localizing, by the processor, a source location for the attack using an angle of arrival (AoA) associated with each of the plurality of suspicious messages to determine a source intersection; and
notifying, by the processor, one or more vehicles of the attack.

2. The method of claim 1, further comprising reporting the attack to one or more authorities.

3. The method of claim 2, further comprising providing the source location to the authorities.

4. The method of claim 1, wherein determining that each of the plurality of messages is suspicious comprises:
determining, by the processor, a message type associated with the message;
calculating, by the processor, the AoA for the message, wherein the AoA is an angle of receipt for the message; and
comparing, by the processor, the AoA to a message angle, wherein the message angle is an expected angle of receipt or angle range for the message based on the message type.

5. The method of claim 1, wherein determining that an attack is occurring further comprises determining that the vehicle network is operating in a degraded state.

6. The method of claim 1, wherein localizing the source location for the attack further uses a received signal strength associated with each of the plurality of suspicious messages.

7. The method of claim 1, wherein the vehicle network is a Vehicle-to-Everything communications network.

8. The method of claim 1, wherein the attack is a denial of service attack or a distributed denial of service attack.

9. A system for determining an attack on a vehicle network and an estimated source location of an attacker, the system comprising:
one or more vehicles, wherein each vehicle comprises:
a memory; and
one or more processors coupled to the memory, wherein the one or more processors are operable to:
receive a plurality of messages;
analyze each of the plurality of messages to determine whether each of the plurality of messages is suspicious;
determine that an attack is occurring in response to a determination that multiple messages of the plurality of messages are suspicious;
localize a source location for the attack using an angle of arrival (AoA) associated with each of the plurality of suspicious messages to determine a source intersection; and
notify one or more vehicles of the attack.

10. The system of claim 9, wherein the processor is further operable to report the attack to one or more authorities.

11. The system of claim 10, wherein the processor is further operable to provide the source location to the authorities.

12. The system of claim 9, wherein the determination that each of the plurality of messages is suspicious comprises:
determining a message type associated with the message;
calculating the AoA for the message, wherein the AoA is an angle of receipt for the message; and
comparing the AoA to a message angle, wherein the message angle is an expected angle of receipt or angle range for the message based on the message type.

13. The system of claim 9, wherein the determination that an attack is occurring further comprises determining that the vehicle network is operating in a degraded state.

14. The system of claim 9, wherein localizing the source location for the attack further uses a received signal strength associated with each of the plurality of suspicious messages.

15. The system of claim 9, wherein the vehicle network is a Vehicle-to-Everything communications network.

16. The system of claim 9, wherein the attack is a denial of service attack or a distributed denial of service attack.

17. A non-transitory computer readable storage medium having program instructions embodied therewith, the program instructions readable by a processor to cause the processor to perform a method for determining an attack on a vehicle network and an estimated source location of an attacker comprising:
receiving a plurality of messages;
analyzing each of the plurality of messages to determine whether each of the plurality of messages is suspicious;
determining that an attack is occurring in response to a determination that multiple messages of the plurality of messages are suspicious;
localizing a source location for the attack using an angle of arrival associated with each of the plurality of suspicious messages to determine a source intersection; and
notifying one or more vehicles of the attack.

18. The computer readable storage medium of claim 17, further comprising reporting the attack to one or more authorities.

19. The computer readable storage medium of claim 17, further comprising providing the source location to the authorities.

20. The computer readable storage medium of claim 17, wherein localizing the source location for the attack further uses a received signal strength associated with each of the plurality of suspicious messages.
